(19) United States
(12) Patent Application Publication
(10) Pub. No.: US 2020/0153954 A1
(43) Pub. Date: May 14, 2020

(54) Cell Phone Floating Device

(71) Applicant: Michael Ray Phillips, Carslbad, CA (US)

(72) Inventor: Michael Ray Phillips, Carslbad, CA (US)

(21) Appl. No.: 16/595,905

(22) Filed: Oct. 8, 2019

Related U.S. Application Data
(60) Provisional application No. 62/757,301, filed on Nov. 8, 2018.

(51) Int. Cl. H04M 1/18; H04B 1/3888

(52) U.S. Cl. CPC H04M 1/18; H04B 2001/3894; H04B 1/3888

(57) ABSTRACT

This invention is directed toward a device capable of keeping a cell phone from sinking when it falls into water. The device has three basic parts. First, a securing band attaches around the cell phone. Second, a float provides enough positive buoyancy to keep the cell phone from sinking. Third, a tether connects the securing band to the float.

### CROSS REFERENCE TO RELATED APPLICATIONS

This application claims priority back to U.S. Provisional Application No. 62/757,301, dated 8 Nov. 2018, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of floatation devices, and more specifically, to a float with a tether to a cell phone retainer, that functions to prevent a cell phone from sinking into a body of water.

### Brief Description of Invention

The invention has a foam float that has enough buoyancy to support the weight of a cell phone, which is tethered to a stretchable band that secures the cell phone, and where the two parts are connected by a tether. The goal of the invention is to prevent a person from losing a cell phone when he/she drops the phone into a river, lake, bay or the ocean. When a cell phone is dropped into water the floatation is the float is greater than the weight in the cell phone, so the float remains on the surface, allowing the cell phone owner to grab the float to retrieve the cell phone.

Creation of the problem this invention solves. Cell phones are generally negatively buoyant, so that they will sink if dropped into water. Many cell phone cases are made from positively buoyant plastic, but do not have enough flotation to keep the cell phone above water; thus, the cell phone sinks to the bottom of whatever body of water it is dropped into. Unless the water is extremely shallow, the dropping of a cell phone into water will require someone to get wet swimming after it, and in many cases the water is too deep and the cell phone will be lost forever.

The prior art has several examples of attempts to resolve this problem. For example, there are on the market today a variety of “lantern harnesses” that tether the cell phone to a person, however, these devices require the user to remember to attach the tether. There are also cases, such as that found in US20180115638, that can be used to keep a cell phone afloat in water, but these require a large amount of foam or other positively buoyant material to keep the cell phone floating, which makes the case too unwieldy to place in a pocket or other constrained space. The prior art also discloses chambered cases, such as that found in US 20110242744, but the resulting structure is, again, too large to place in a pocket for easy access and transportation.

Thus, there has existed a long-felt need for means by which a cell phone can be protected from sinking, and at the same time not make the cell phone so large it cannot fit in a person's pocket.

The current invention provides just such a solution by having a three-part invention that has a securing band attached to a tether, which is, in turn, attached to a float. The float can be work outside of a pocket such that the phone can be transported within the pocket, but if the cell phone falls in the water, it will not sink because of the float.

### OBJECTS OF THE INVENTION

It is therefore an object of the present invention to provide a band that can secure a cell phone to a tether.

An additional object of the invention includes having a float capable of preventing a cell phone from sinking that is connected to the cell phone by a tether.

A further object of the invention is to allow for a variety of advertising images to be placed on the band, on the float, and on the tether if the tether is a strap.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of the invention.

### REFERENCE NUMBERS USED

1. Float
2. Tether
3. Band
4. Float connection
5. Band connection
6. Cell phone

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

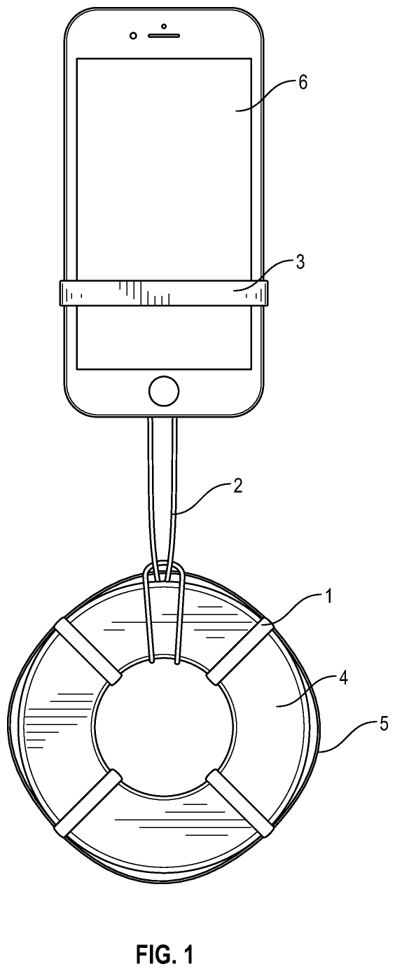

FIG. 1 is a perspective view of the invention. A float 1 provides buoyancy to hold a cell phone 6 above water should it fall into the water. The float 1 is secured to a band 3 that secures the cell phone 6 by a tether 2. The tether is secured to the float 1 at a float connection 4, and secured to the band 3 at a band connection 5.

The band 3 has a number of unique characteristics that make it efficient for this purpose. It is important that the band be removable, as a user would not want to keep the band attached to the phone permanently, and yet is has to be snug-fitting enough so that the phone does not slip out of the band in the water. The band also cannot “stretch out” over time to the point where it no longer provides a snug fit.

To meet this need, the band has a memory of, optimally, 99.8% to 99.95%, where “memory” is the ability of a band to return to its original shape after having been stretched. This strong memory prevents the band from loosening over time and giving the user a false sense of security.

The band also has, in a preferred embodiment, a permanent set of between 7.0 and 7.4, with a particularly preferred embodiment has a permanent set of 7.2, where the permanent set is the percentage of extension of a band from its resting position to its length right after stretching. This low permanent set allows the band to maintain a snug grip on the cell phone over a long period of time.

To achieve these characteristics, the band, in a preferred embodiment, has a thickness of 2 mm, a width of 30 mm, and a length of 185 mm, with an elongation of 12 cm, and an ultimate elongation of 15 cm. A preferred embodiment calls for a band with a specific gravity of at least 1.1, and preferably 1.26, with a durometer of between 35 and 45, preferably at 42.

In a preferred embodiment, the invention consists of: a float, a tether, and a band, where the band encircles and secures a cell phone, where the float has float positive buoyancy, where the tether connects the float and the band, where the band has a memory between 99.8% and 99.95%, where the band has a permanent set between 7.0 and 7.4, where the band has a thickness of 2 mm, a width of 30 mm, and a length of 185 mm, where the band has a specific gravity of between 1.1 and 1.26, where the band has an elongation of 12 cm and an ultimate elongation of 15 cm, and where the band has a durometer between 35 and 45.

In this embodiment, the memory is 99.90%, where the permanent set is 7.2, and where the durometer is 42, and the tether can be a strap or a rope, and the float is shaped like a life preserver.

In another embodiment, the invention comprises the float, the tether, and the band, where the band encircles and secures a cell phone, where the float has float positive buoyancy, where the tether connects the float and the band, where the float positive buoyancy is sufficient to prevent the cell phone from sinking in the water. The tether can be a rope or a strap, and the band exerts a band pressure on the cell phone, which is adequate to secure the cell phone.

In this embodiment, the band has the memory between 99.8% and 99.95%.

The device of Claim 11, where the band has a permanent set between 7.0 and 7.4, a thickness of 2 mm, a width of 30 mm, and a length of 185 mm, a specific gravity of between 1.1 and 1.26, an elongation of 12 cm and an ultimate elongation of 15 cm, with a durometer between 35 and 45.

In a slightly different embodiment, the float is shaped like a life ring or life preserver, and the band has the memory between 99.8% and 99.95%, where the band has a permanent set between 7.0 and 7.4, where the band has a thickness of 2 mm, a width of 30 mm, and a length of 185 mm, where the band has a specific gravity of between 1.1 and 1.26, where the band has an elongation of 12 cm and an ultimate elongation of 15 cm, and where the band has a durometer between 35 and 45, and where the shape is a life ring.

In an alternate embodiment, the memory is 99.90%, where the permanent set is 7.2, and where the durometer is 42.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device for preventing a cell phone from sinking in water, consisting of: a float, a tether, and a band, where the band encircles and secures a cell phone, where the float has float positive buoyancy, where the tether connects the float and the band, where the band has a memory between 99.8% and 99.95%, where the band has a permanent set between 7.0 and 7.4, where the band has a thickness of 2 mm, a width of 30 mm, and a length of 185 mm, where the band has a specific gravity of between 1.1 and 1.26, where the band has an elongation of 12 cm and an ultimate elongation of 15 cm, and where the band has a durometer between 35 and 45.

2. The device of claim 1, where the memory is 99.90%, where the permanent set is 7.2, and where the durometer is 42.

3. The device of claim 2, where the tether is a strap.

4. The device of claim 2, where the tether is a rope.

5. The device of claim 2, where the float has a shape, and the shape is a life ring.

6. A device for preventing a cell phone from sinking in water, comprising: the float, the tether, and the band, where the band encircles and secures a cell phone, where the float has float positive buoyancy, where the tether connects the float and the band.

7. The device of claim 6, where the float positive buoyancy is sufficient to prevent the cell phone from sinking in the water.

8. The device of claim 7, where the tether is a rope.

9. The device of claim 7, where the tether is a strap.

10. The device of claim 7, where the band exerts a band pressure on the cell phone.

11. The device of claim 10, where the band pressure is adequate to secure the cell phone.

12. The device of claim 11, where the band has the memory between 99.8% and 99.95%.

13. The device of claim 11, where the band has a permanent set between 7.0 and 7.4.

14. The device of claim 11, where the band has a thickness of 2 mm, a width of 30 mm, and a length of 185 mm.

15. The device of claim 11, where the band has a specific gravity of between 1.1 and 1.26.

16. The device of claim 11, where the band has an elongation of 12 cm and an ultimate elongation of 15 cm.

17. The device of claim 11, where the band has a durometer between 35 and 45.

18. The device of claim 11, where the shape is a life ring.

19. The device of claim 11, where the band has the memory between 99.8% and 99.95%, where the band has a permanent set between 7.0 and 7.4, where the band has a thickness of 2 mm, a width of 30 mm, and a length of 185 mm, where the band has a specific gravity of between 1.1 and 1.26, where the band has an elongation of 12 cm and an ultimate elongation of 15 cm, and where the band has a durometer between 35 and 45, and where the shape is a life ring.

20. The device of claim 19, where the memory is 99.90%, where the permanent set is 7.2, and where the durometer is 42.
